(19) United States
(12) Patent Application Publication
(10) Pub. No.: US 2023/0373454 A1
(43) Pub. Date: Nov. 23, 2023

(54) Accelerator-brake converter

(71) Applicant: JREX Co., Ltd.

(72) Inventor: Shigeki OKAZAKI, Hyogo (JP)

(73) Assignee: JREX Co., Ltd., Hyogo (JP)

(21) Appl. No.: 17/747,405

(22) Filed: May 18, 2022

(51) Int. Cl. B60T 17/18; B60T 13/66; B60T 7/04; B60K 26/02; B60T 7/12

(52) U.S. Cl. CPC B60T 17/18; B60T 13/662; B60T 7/042; B60K 26/02; B60T 7/12; B60T 2220/06; B60T 2220/04; B60T 2270/413

(57) ABSTRACT

A system and a device shut off the accelerator function and converts the accelerator function immediately into a brake function for safety in the event of a malfunction when the accelerator pedal is accidentally depressed by a panic or the like. A new finding correlation data showing a relationship between a driver's body weight W and a pedal stepping force F is obtained, and based on this, an accelerator-brake switching set value A is determined, and an accelerator mechanism which detects a stepping pressure F(s) by a pressure sensor and when the stepping force F exceeds over a set value A, that is, F(s)≥0.8×W×(X/Y), it is determined that an abnormal operation happens, so then the brake sensor sends an emergency signal to ECU to stop the throttle driving means, and also actuate the brake driving means through ECU.

### BACKGROUND OF THE INVENTION

### Field of the Invention

The present invention relates to a system for shutting off an accelerator function and converting it immediately into a brake function for safety in the event of a malfunction when the accelerator pedal is accidentally depressed deeply by a panic action or the like, and also relates to a digital type or an analog type accelerator-brake converter to which the present invention system can be also applied. Especially, the present digital type and analog type accelerator-brake converter device can perform an accelerator operation without malfunction in a normal acceleration operation, whereas when a driver is panic and accidentally pushes the accelerator further and strongly, the operation is detected by an emergency means which is operated by a stepping force sensor, and the accelerator operation is shut off through an ECU (engine control unit) so that it can be automatically converted to the brake function.

### Description of the Related Art

When a beginner or an elderly person drives a vehicle, the whole body may become stiff due to fear of an unexpected starting speed. In addition, if the accelerator pedal is mistakenly operated deeply by mistake with the brake pedal during driving, the speed increases contrary to the feeling of the driver, and the accelerator pedal may be further depressed instead of applying the brake.

In such a situation, the foot stays on the accelerator pedal, and the accelerator pedal is forced to fully be depressed (corresponding to the total output of the motor in the case of an electric vehicle), resulting in a fear that the car will not stop until it collides with an obstacle, leading to a serious injury or death. On the other hand, there have been proposed a lot of devices capable of avoiding a collision against an obstacle due to an accidental depression of an accelerator pedal and reliably preventing a personal injury accident (Patent Document 1, Patent Document 2, and Patent Document 3).

For example, as shown in the Patent Document 1, when the arm of the brake pedal is linked by the arm of the accelerator pedal and the transmission member, and the arm of the accelerator pedal is depressed up to an angle exceeding the maximum angle of the normal depression range, the arm of the brake pedal is swung in the depression direction together with the arm of the accelerator pedal for the braking, and then when the depression angle of the arm of the accelerator pedal is further increased, the accelerator is released from the connection between the arm of the accelerator pedal, and the throttle valve and the accelerator is back to the original position, so that the runaway of the vehicle is suppressed.

Further, as shown in the Patent Document 4, the movable range of the accelerator pedal is divided into the normal area and the emergency area, and when the accelerator is depressed mistakenly during panic, the pedal is depressed with a greater force than the normal accelerator operation, so that when the depression exceeds over the normal area and enters into the emergency area, it is determined that the accelerator is stepped on incorrectly when the access is depressed with an excessive force in this way, so that the acceleration force is immediately cut together with the braking application.

### PRIOR ART DOCUMENTS

### Patent Document

[Patent Document 1] Japanese Utility Model Registration No. 3,217,039
[Patent Document 2] Japanese Patent No. 4,598,207
[Patent Document 3] Japanese Patent No. 5,355,800
[Patent Document 4] JP-A-2013-56653 publication

### SUMMARY OF THE INVENTION

However, in the apparatus described in Patent Document 1, since the brake is activated by the arm of the brake pedal linked with accelerator when the accelerator pedal is largely depressed above a certain position, it is a problem that such a braking function happens when the accelerator pedal is strongly depressed in an attempt to accelerate at a normal time.

Further, in the apparatus described in Patent Document 2 since it is necessary to depress the pedal by tilting the foot, an unnatural posture becomes forced during operation, so that if you do not watch that you are constantly operating the accelerator pedal, the braking happens when you strongly depress the pedal during the intentional acceleration, so that there is a possibility that the driver may become panic due to sudden brake in some cases.

Furthermore, in the apparatus according to Patent Documents 3 and 4, although it is proposed that the movable range of the accelerator pedal is simply divided into a normal area and an emergency area, and at a boundary of change from the accelerator to the brake, the load is changed from small to large, the stepping is naturally deep when the driver presses the pedal strongly to perform intentional acceleration, and there sometimes occurs an accident. In such cases it sometimes becomes a sudden brake and the driver easily falls in panic.

In view of such problems, it is an object of the present invention to provide a digital type and an analog type accelerator-brake conversion device that can safely perform an ordinary acceleration operation without malfunction, whereas the brake operation is certainly performed only when the driver is panic and the accelerator pedal is accidentally stepped on to a greater extent, that is, a malfunction of the brake operation is avoided during a normal accelerator operation, and a runaway due to an accelerator operation caused by a stepping error is prevented.

### Means for Solving the Problems

The inventor of the present invention gazed attention to the panic operation with respect to stopping the runaway due to the irregular accelerator operation by a mistaken or wrong stepping, and as a result of intensive research, and it is surprisingly found that there is a clearly distinguishable difference between the normal accelerator operation and the panic accelerator operation. The major difference appears in the stepping down action. That is, when the driver becomes panic during driving and falls into an abnormal situation, and the accelerator pedal is stepped down incorrectly as the brake pedal, 1) the physical feature appears as an unconscious forward protrusion of the foot, and as a result, 2) the action of stepping on the accelerator pedal abnormally quickly and strongly appears remarkably. Therefore, it is an object of the present invention to provide a safe system by incorporating these two major features into a countermeasure against mistake. Further, the inventor of the present invention have found that, 3) although the pedaling acceleration speed of the accelerator pedal is one of the two main features, it tends to be changed depending on the driver, so that liability is insufficient, whereas the pedaling force of the accelerator pedal is adjusted usually to 5 kg to 10 kg at normal operation and is increased to 15 kg even during sudden acceleration at the time of the car overtaking, the inventor has found that 4) the maximum stepping force (mental limit) at normal operation is correlated with the driver's body weight, from 80% to 100% of the body weight, and that in a panic state, the pedaling force is increased by about 25% of the mental limit value (physiological limit value), which was confirmed by experiments. That is, the maximum depressing force (mental limit) at normal time correlates with the above-mentioned driver's weight (see FIG. 2), but it was found that, unlike normal accelerator operation, the mental limit value in accelerator operation during panic is within the range of 80% to 100% of the driver's weight value, although there are differences among the drivers. Therefore, in order to consider the driver's malfunction and ensure safety, we obtained a new knowledge that discrimination between the normal accelerator operation and the panic accelerator operation by considering the mental limit value fluctuating due to the driver's body weight is the most important for performing truly opposite operation switching (between accelerator and brake). That is, in the operation control during panic, even if the switching between the accelerator and the brake is too effective or not too effective, it does not become appropriate safety control. Therefore, taking the correlation data shown in FIG. 2 into consideration, the set value A may be determined and set preferably from 70% to 90% of the body weight.

And, it is desirable to use an analog type malfunction prevention system together with a digital type without relying only on a digital type malfunction prevention system to ensure more safety. As mentioned above, although the prior art proposed a mechanism where the accelerator movable range is divided into a normal movable range and a panic movable range and each range can be made in a manner to provide a load difference in the stepping-on operation, it is a big problem that there remains a psychological anxiety that the braking may happen also in a normal state, or if the operation switching criterion is uniformly provided, there is a feeling of anxiety that the braking may not operate even in an emergency, which is psychologically insufficient. In order to remove such a sense of anxiety, there need also a good contrivance in the case of installing an analog system.

Considering the psychological aspects of the driver, therefore, it was found that not only 1) a structural contrivance in which an emergency operation base for operating a brake should be provided and an normal accelerator mechanism for operating a normal acceleration operation should be mounted on the emergency operation base, but also 2) a new finding knowledge of the inventor in which a perfect safety device can be constructed by the emergency operation base construction which is provided with a depressing spring load equal to or greater than a setting value (a mental limit value) A of the accelerator pedal in consideration of the driver's weight W.

The present invention is a system for preventing erroneous operation and runaway based on such knowledge.

Firstly, the present invention focuses on the driver's behavior in the event of an abnormality, and based on the finding that the forward protrusion of the driver's legs in the event of an abnormality correlates with the driver's weight, the present invention has been completed on the basis of this function. The present invention provides a digital system for preventing improper stepping erroneously operated runaway characterized in that, 1) firstly correlation data (FIG. 2) indicating the relationship between the driver's weight W and the depression force F in the event of a panic is obtained, from which correlation data accelerator/brake switching setting value (the lower limit mental value) A correlated with the driver's weight, and this setting value A is hold in the artificial intelligence unit AI of the ECU, while providing a pressure sensor at the accelerator pedal mounting base to detect the accelerator pedal depression pressure or force F(s) of the driver, and transmits the signal of the depression force F(s) to the artificial intelligence unit AI of the ECU, and compares the depression force F(s) with the set value A of the accelerator signal within the artificial intelligence unit AI, and when the accelerator signal is smaller than the normal accelerator signal (F(s)<A), it is determined that the operation is a normal accelerator operation, and a driving continue signal D-yes is output, while when the stepping force F(s) is greater than or equal to the set value A (F(s)≥A), it is determined that the operation is an abnormal accelerator operation, and the operation stop signal D-no is output, and the throttle drive means is stopped via the engine control unit (ECU), while the brake drive means is operated, and the normal brake and/or the electric parking brake is operated.

Second, the present invention is to provide an analog malfunction prevention system which can be applied in cooperation with the above digital malfunction prevention system or independently of the digital malfunction prevention system. In the analogue devise, although the operating range of the accelerator petal is divided into two operating areas: a normal accelerator operating area and a brake operating area in an emergency, it is important that an normal accelerator mechanism for operating the accelerator pedal is provided on an emergency operating board for operating the brake, and biased by a spring force determined from correlation data (FIG. 2) indicating the relationship between the weight of the driver W and the depression force F. In this case, the accelerator/brake switching setting value (mental limit value) A (FIG. 3) related to the weight W of the driver is set for switching the operation between the acceleration and braking of the accelerator pedal. Under the set value A, the stepping force F(s) of the normal operation is at a state of less than the accelerator switching setting value A (F(s)<A), so that the accelerator pedal does operate with a depression force in an normal state, while a stepping force F(s) becomes equal to or more than a set value A (F(s) A), the emergency operation board begins to be operated in response to this, and the throttle driving means is stopped, while the brake driving means is operated, and the normal brake and/or the electric parking brake is operated.

### Effect of the Invention

According to the stepping error misoperation runaway prevention system of the present invention, whether or not the operation exceeds over the mental limit value A of the driver is detected by the accelerator depressing force F(s), and the abnormal operation at the time of the panic is detected in comparison with the accelerator-brake switching set value (the mental limit value) A which is set in advance, that is, (F(s)<A) or (F(s)≥A) is detected, so that the control can be accurately performed.

Such control may also be implemented by employing either the digital or the analog system, or both, if any. If both digital and analog systems can be adopted, an ideal safety is ensured by double safety systems, so that no loss of control due to an unexpected failure will occur.

Furthermore, in recent years, since the almost of automobile are provided with a vehicle-to-vehicle distance automatic control system (ECU) as shown in FIG. 9, it is easy to operate the vehicle-to-vehicle distance automatic control system (ECU) by receiving a brake signal due to malfunction from the system of the present invention to prevent malfunction.

### BRIEF DESCRIPTION OF THE DRAWINGS

FIG. 1 It is a schematic diagram of a digital malfunction runaway prevention system according to the present invention.

FIG. 2 It is a graph showing the correlation between the weight of the driver and the accelerator pedal depression force F shows the relation between the weight W and the lower limit value F1 to the upper limit value F2 of the mental limit.

FIG. 3 It is a selection explanatory view of the biasing force spring drag value type A, type B, type C, type D and type E according to the driver's body weight, which is adopted according to the basis of the correlation graph of FIG. 2 in an analog system.

FIG. 4 It is a specific example of an accelerator pedal mechanism employed in the present invention, wherein an emergency tilting base substrate 106 is used, and a normal accelerator pedal mechanism is mounted on the emergency tilting base substrate 106 that operates after the stepping force equal to or higher than a set value A is applied to the biasing spring 107.

FIG. 5 It is a modification of the accelerator pedal mechanism employed in the present invention, wherein the emergency tilt base substrate is not used, and an operation load equal to or higher than a set value (the mental limit value) A is applied by the biasing spring 109 to the normal accelerator pedal mechanism 105, where X is the distance from the fulcrum of the accelerator pedal mechanism to the force point on the pedal, Y is the distance from the fulcrum of the accelerator pedal mechanism to the sensor action point, and l is ON/OFF switching stroke.

FIG. 6 It is a schematic diagram of a digital system of the present invention;

FIG. 7 It is a control flow of the digital system of the present invention.

FIG. 8 It is a flowchart of the AI of the present invention.

FIG. 9 It is a schematic diagram of an inter-vehicle automatic control system applied to the digital system of the present invention.

FIG. 10 It is a schematic diagram of an organ type accelerator pedal applied to the present invention;

FIG. 11 It is a schematic perspective view showing a preferred embodiment of an analog accelerator-brake composite transforming pedal device according to the present invention.

FIG. 12 It is a schematic perspective view showing the structure of the above embodiment.

FIG. 13 It is a side view showing a configuration of a main part in the above embodiment.

FIG. 14 It is a schematic perspective view showing a second embodiment;

FIG. 15 It is a schematic side view showing a modification of the accelerator-brake converter in the second embodiment.

FIG. 16 It is a schematic perspective view of another embodiment showing accelerator petals biased by winding springs which is installed on the emergency operation base biased by a coil spring, wherein flange pieces protrude from the side of the emergency operation base for pressing the brake switch.

FIG. 17 It is a first modification view of the case of eliminating the emergency operation base of FIG. 16.

FIG. 18 It is a second modification view of FIG. 16.

FIG. 19 It is a third modification view of FIG. 16.

FIG. 20 It is a typical flow sheet of the runaway prevention system of the present invention.

### DETAILED DESCRIPTION OF THE INVENTION

Hereinafter, the preferable specific example of the present invention is described based on the following drawings.

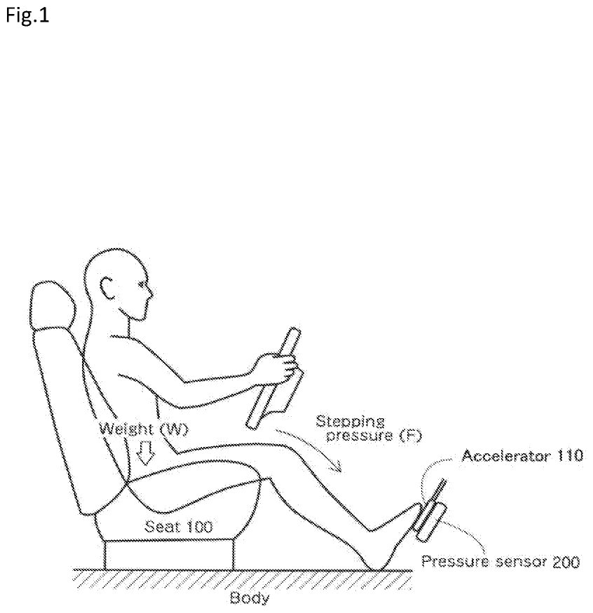

First, the present invention is applied to an automobile in which, when a driver seats down on a seat 100 as shown in FIG. 1, an accelerator operation will begin, and then a throttle drive or motor drive means is actuated by receiving a signal of a position of an accelerator pedal (110) through an accelerator pressure sensor (200), while an accelerator pedal is biased toward a non-depressed initial position and is provided to operate a throttle opening or motor drive adjustment operation in relation to the operation of the accelerator pedal (110).

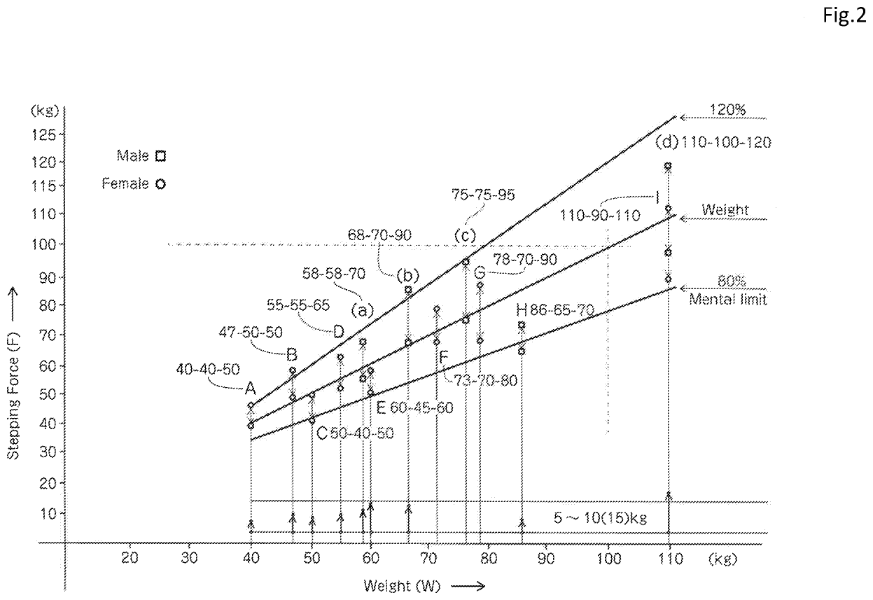

In the present invention, the correlation data (FIG. 2) showing the relationship between the driver's weight W and the stepping or depressing force F in an emergency is obtained, on the basis of which the accelerator/brake switching set value (mental limit value) A is determined, and this set value A is held in an artificial intelligence device AI of the ECU, while the depressing pressure F (s) of the driver's accelerator pedal is detected, and the depressing pressure F (s) is transmitted to the artificial intelligence device AI of the ECU, in which the depressing pressure F (s) is compared with the set value A. When the depressing pressure F(s) is smaller than the set value A (F(s)<A), it is judged as normal accelerator operation, while when the depressing pressure F(s) is larger than or equal to the set value A (F(s)≥A), it is judged as abnormal accelerator operation, and the throttle driving means is stopped via the engine control unit (ECU).

(Correlation Data between Driver Weight W and Emergency Depression Force F)

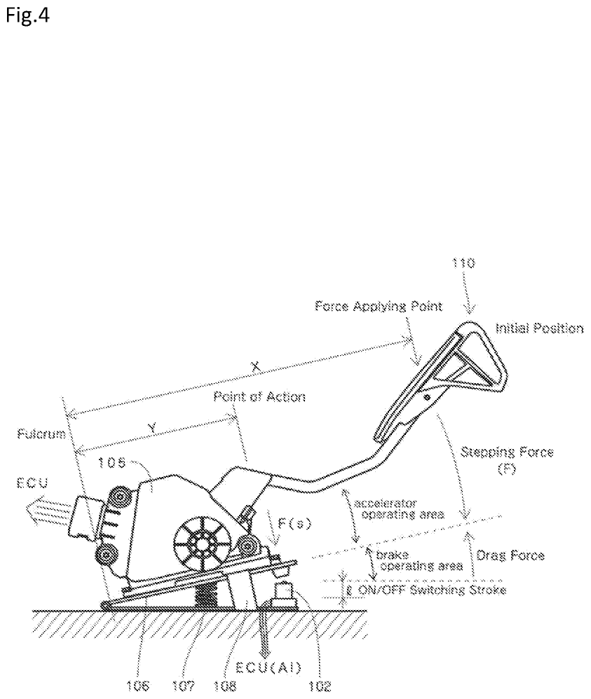

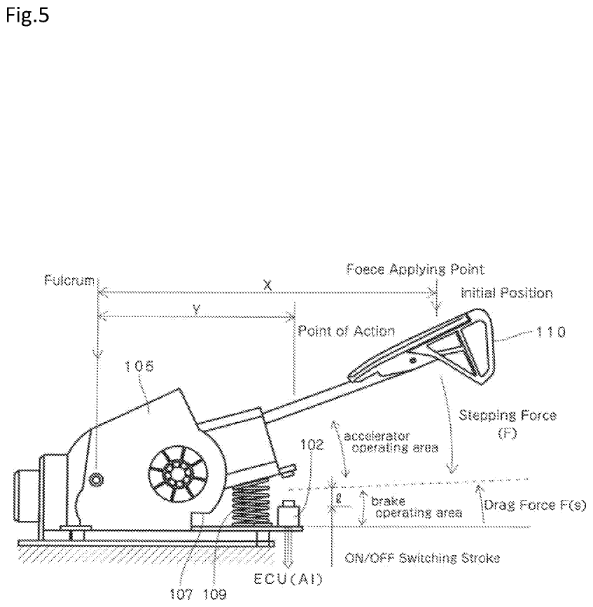

To determine the relationship between the driver weight W and the depressing force F in an emergency in the present invention, the experimental method shown in FIG. 1 was adopted. That is, the driver sits down on the seat (100), and after adjusting the seat to a good position, the body weight W of the seated driver is measured in the seated position. The depressing pressure F(s) of the accelerator pedal is as follows: A pressure sensor (200) is provided near the last depressing position of the accelerator pedal (110), and the depressing pressure (depressing pressure when the foot is pushed forward fully) F (s) in an emergency was measured 10 times, and the lower limit F1 and the upper limit F2 were measured. As the accelerator pedal mechanism, there are two types; one is an embodiment of FIG. 4 and the other is an embodiment of FIG. 5. In FIG. 4, the engine can be controlled by sending the depressing signal to the ECU by the accelerator mechanism (105) driven by the depressing force. The normal accelerator mechanism (105) is mounted on a brake drive support substrate (106) for braking, and the support substrate is configured to provide a drag force (set value) A that is correlated with the weight W of a driver seated in the present invention by a first biasing spring (107). (102) is a pressure sensor for depressing force input, when the depressing pressure exceeds over the set value A and the pedal enters into the brake operation area from the normal operation area, the tip of the support substrate 106 is in contact with the sensor 102, which will emit a brake signal. In contrast, FIG. 5 does not provide a tilting support substrate 106, where a pressure sensor 102 is provided in front of the accelerator pedal swing spring 109, so the brake signal is transmitted in operation at the final stage.

In the experiment of the present invention, the mechanism of FIG. 4 was adopted based on the concept of FIG. 1, and the result of FIG. 2 was obtained. O Marks indicate women and □ Marks indicate men. As a result, as shown in FIG. 2, the lower limit value of the depressing force at the time of emergency was 40 kgf and the upper limit value was 50 kgf in the case of the female A of 40 kg. In a case of 47 kg female B, the upper limit of the depressing force was 60 kgf, while the lower limit of the depressing force at the time of emergency was 50 kgf. In a case of female C with 50 kg, the lower limit of the depression force was 40 kgf, while the upper limit of the depression force was 50 kgf. In a case of female D with 55 kg, the lower limit value in emergency was 58 kgf, the upper limit value was 65 kgf. In a case of female E of 58 kg, the depressing force upper limit value was 60 kgf, while the depressing force lower limit value in the emergency was 58 kgf. For the 73 kg female F, the upper limit of the depression force was 80 kgf, while the lower limit of the depression force was 70 kgf. In a case of 78-kg woman G, the upper limit of the depressing force was 90 kgf while the lower limit of the depressing force at the time of emergency was 70 kgf. In a case of female H with 86 kg, the depressing force lower limit in the emergency was 65 kgf, while the depressing force upper limit showed 70 kgf. In a case of women I with 110 kgf, the upper limit was 110 kgf, while the lower limit was 90 kgf.

On the other hand, in the case of a male of 58 kg (a), the lower limit of the depressing force at the time of emergency was 58 kgf, while the upper limit of the depressing force was 70 kgf; in the case of a male of 68 kg (b), the lower limit of the normal depressing force at the time of emergency was 70 kgf, while the upper limit of the depressing force was 90 kgf; in the case of a male of 75 kg (c), the lower limit of the depressing force at the time of emergency was 75 kgf, while the upper limit of the depressing force at the time of emergency was 95 kgf; in the case of a male of 110 kg (d), the lower limit of the depressing force at the time of emergency was 90 kgf, while the upper limit of the depressing force at the time of emergency was 120 kgf.

Looking at the correlation between 1) the weight W of the driver and 2) the emergency depression force lower limit value F1 and the emergency depression force upper limit value F2, it was found that the fluctuation from the depression force F1 to the depression force F2 was slightly different depending on the female and male cases, but exceeded the 80% line of the body weight W and did not exceed over the 125% line of the body weight W, even when the fluctuation of the depression force was taken into consideration. Therefore, when the weight is measured to determine the accelerator-brake switching set value A and control the malfunction prevention system, it can be understood that it is preferable to set the switching set value A to the 80% line of the driver's weight exceeding over the lower limit of the stepping force of any driver. This tendency is shown in the graph of FIG. 2.

(Relation between the depressing force F and the measured depressing pressure F(s))

The depressing force F of the accelerator pedal and the sensed value F(s) of the pressure sensor are indicated by the following relationship. The relationship between the body weight W and the depression force F is the pressure at which the subject depresses the accelerator pedal 110 as shown in FIG. 4, and is not the pressure against the pressure sensor 102. Therefore, the data value (Fs) of the depression force input to the AI is expressed as follows.

If the distance from the fulcrum to the accelerator depressing point (force point) is X and the distance from the fulcrum to the pressure sensor (action point) when the accelerator is depressed is Y, the relationship between the depressing force F and the measured depressing pressure F (s) can be expressed by the formula X×F=Y x F (s),

The accelerator depressing pressure F(s)=depressing force F×X/Y. (X/Y) differs depending on the automobile manufacturers and the vehicle types.

Thus, in one specific example of the present invention, F(s)<0.8×W×(X/Y) is judged as a normal depression force, while F(s)≥0.8×W×(X/Y) is judged as an abnormality, and the relationship between the body weight W and the depression force F is grasped as a numerical value, and can be quantitatively compared and judged.

In addition, 80% of the body weight W of both men and women may be changed according to the accelerator brake switching standard line, or the lower set value A may be adjusted between 70% and 90%.

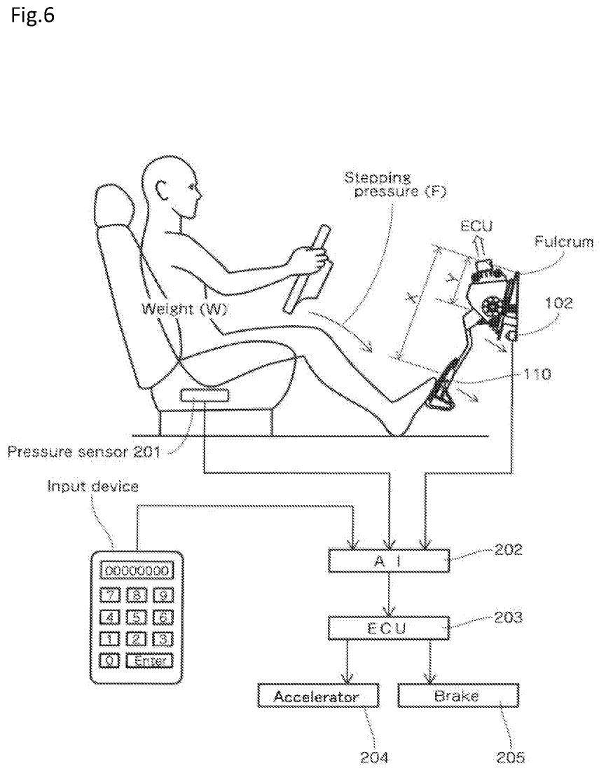

FIG. 6 is a flow chart of the digital control method of the present invention. While the body weight W of the seated driver is measured by the seat pressure sensor (201) and is input to the AI means (202), the driver's depressing force F is detected by the depressing pressure sensor (102) when the accelerator pedal (110) enters into the emergency brake operation area from the normal accelerator operation area, the signal is sent to the AI means (202), and is compared with the driver correlation value A, and finally F (s)≥0.8×W×(X/Y) is determined to be abnormal, and is sent to ECU (203) to stop the accelerator control while starting the brake control.

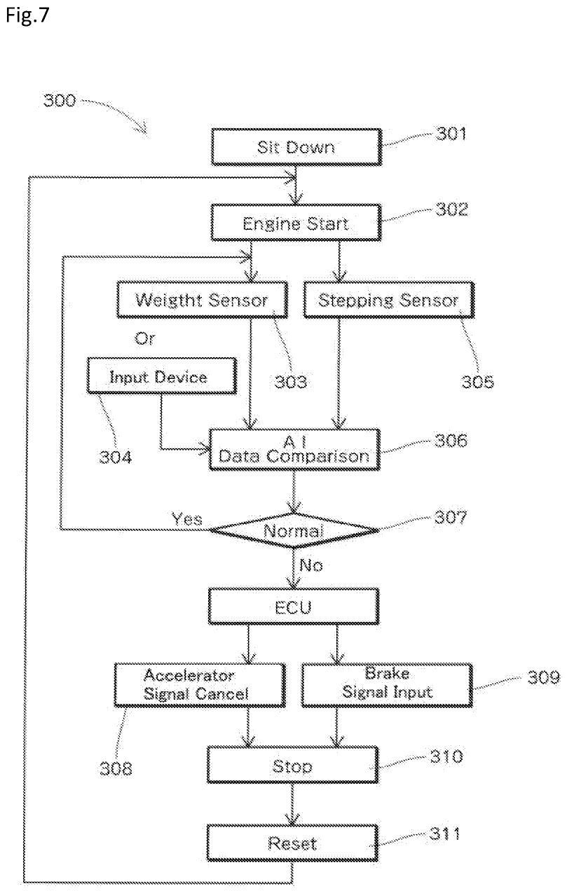

Specifically, in the digital control system, it is controlled as shown in FIG. 7. When the driver is seated (301) and the engine is started (302), the sensor (303) measures the driver's weight W and sends it to the AI means (306). The body weight W can also be input to the AI means (306) by the manual means (304). On the other hand, when the driver operates the accelerator, the depressing pressure F (s) is sent from the depressing sensor (305) to the AI means (306). The AI means (306) compares the body weight W and the depression pressure F(s), and when the depression pressure F(s) is less than the switching set value A, it is judged that the normal depression force is a normal operation, while when F(s) is equal to or greater than 0.8×W×(X/Y), it is judged as the abnormality and the signal No is transmitted to the ECU (307), the accelerator control means (308) closes the throttle, and the brake control means (309) applies the brake to stop the vehicle.(310). Resetting by reset means (311) then initiates normal engine operation.

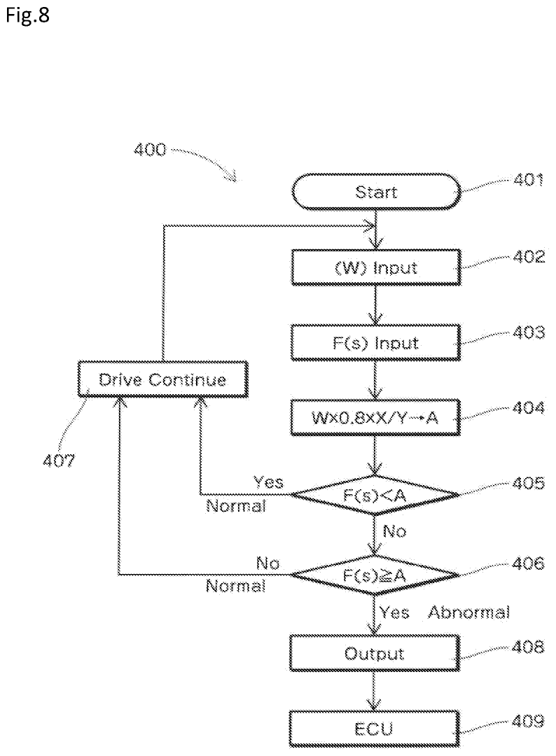

The AI means (306) shown in FIG. 7 performs control based on the flow shown in FIG. 8. The weight W is input (402) together with the engine start (401). On the other hand, the depressing pressure set value A=F (s) is input (403). Based on the correlation data diagram shown in FIG. 2 between the body weight W and the depressing force F, the AI unit (306) inputs the accelerator-brake switching set value A of A=0.8×W×(X/Y) (404), when the depressing pressure F (s) is less than the switching set value A=F (s)≤0.8×W×(X/Y), F (s) is determined to be a normal depressing force (405), and the driving operation continues (407). On the other hand, when the depression pressure F(s) becomes equal to or exceeds over the switching set value A, it is determined that F(s)≥0.8×W×(X/Y) is abnormal (406), and this is output (408), and the abnormality signal No is transmitted to the ECU (409). If an alarm signal is sent to the driver in advance, the alarm can be triggered when the pressure signal sensed by the pressure sensor reaches 65%.

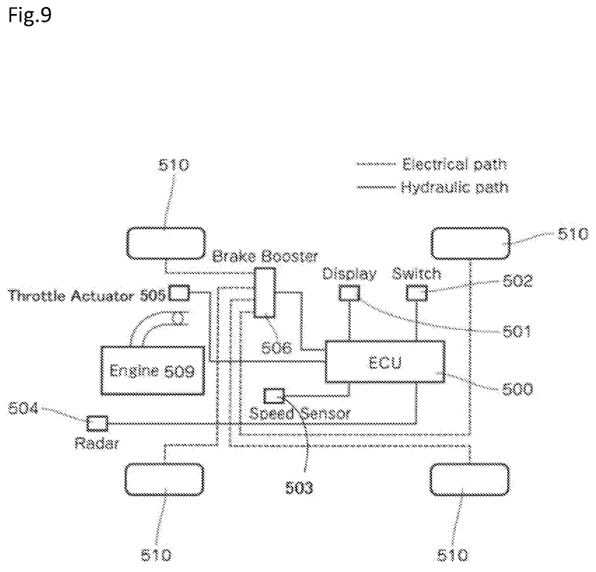

In ECU (500), the following control can be performed by using the vehicle-to-vehicle automatic control system shown in FIG. 9. This system is usually equipped with a radar sensor (504) for launching millimeter-waves and a vehicle speed sensor (503), as well as a throttle sensor (505) and a brake booster (506) control unit, and the like, so as to automatically control the vehicle-to-vehicle distance from the front vehicle on an expressway or the like, and if the distance from the front vehicle becomes too close, the brake can be automatically activated to avoid danger. In the present invention, when an emergency signal is output from the ECU (500), the emergency signal is sent to the brake booster (506), and then the wheel (510) is braked while the emergency signal is also sent to the throttle actuator (505) and then the engine (509) can be stopped via the throttle actuator (505). In FIG. 9, (501) shows an ECU control display, while (502) shows an engine switch.

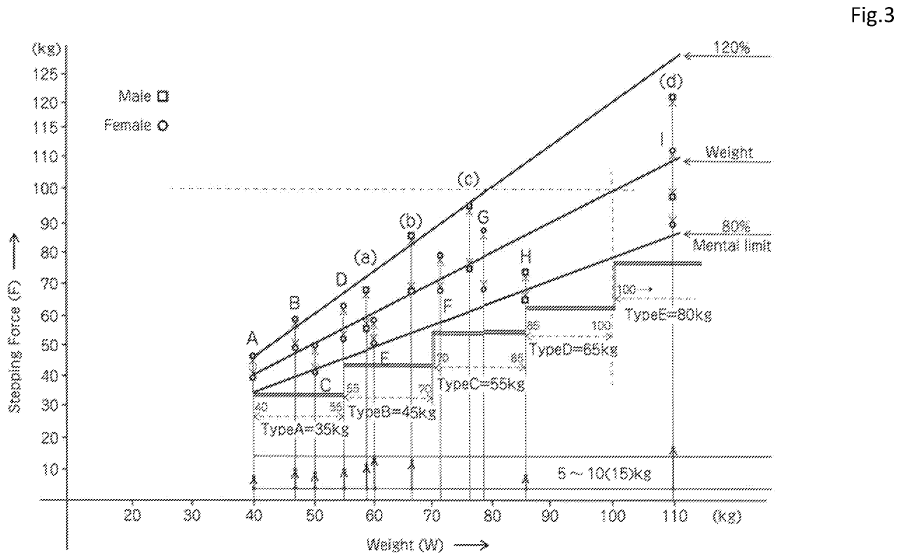

In the above digital control system, the mental limit value line can be finely set by the intersection with the calibration curve of the 80% weight line as shown FIG. 2, but in the analog control system, the emergency action is adjusted by the biasing force spring drag value A as shown in FIG. 3 which determines the working force by the spring (15) of the substrate (11) supporting the accelerator mechanism with the pedal (12). Spring drag can be adjusted approximately steplessly when adjusted by electromagnetic force or air pressure, but it is preferable to adjust stepwise when adjusted by a coil spring or a leaf spring or the like. In the case of FIG. 3, where the control is divided into five stages as illustrated. That is, in the case of from 40 kg to 55 Kg of body weight (Type A), the spring drag was made to be 35 kgf, in the case of 55 kg to 70 kg (Type B), the spring drag was made to be 45 kgf, in the case of 75 kg to 85 Kg of body weight (Type C), the spring drag was made to be 55 kgf, in the case of 85 kg to 100 kg (Type D), the spring drag was made to be 65 kgf, and in the case of 100 kg to 125 kg (Type E), the spring drag was made to be 80 kgf. FIG. 3 is a standard segmentation method, which segmentation can be reduced by increasing the number of segments, and can be segmented in consideration of gender differences. Generally, in the normal accelerator operation, the depressing force at the time of sudden accelerator is 5 to 10 kg weight, including when passing the front car and joining the main line, and at most 15 kg weight.

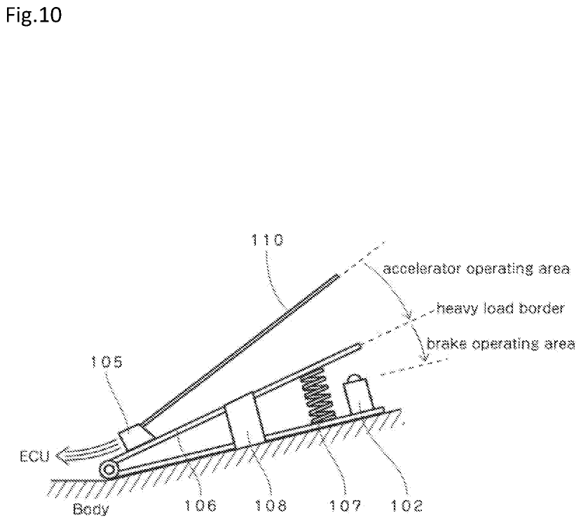

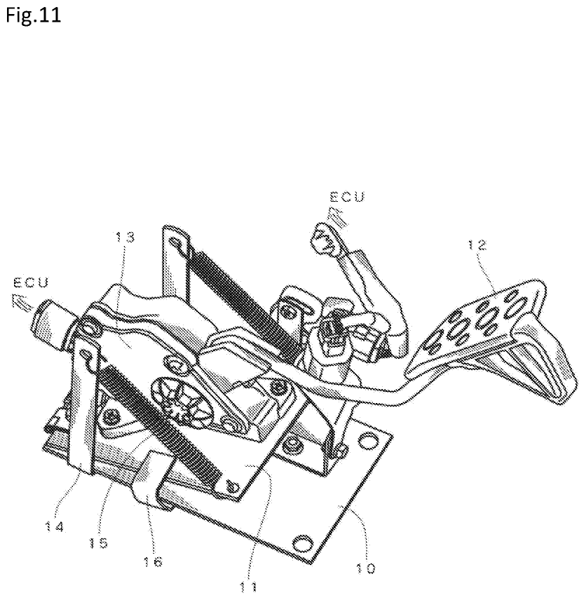

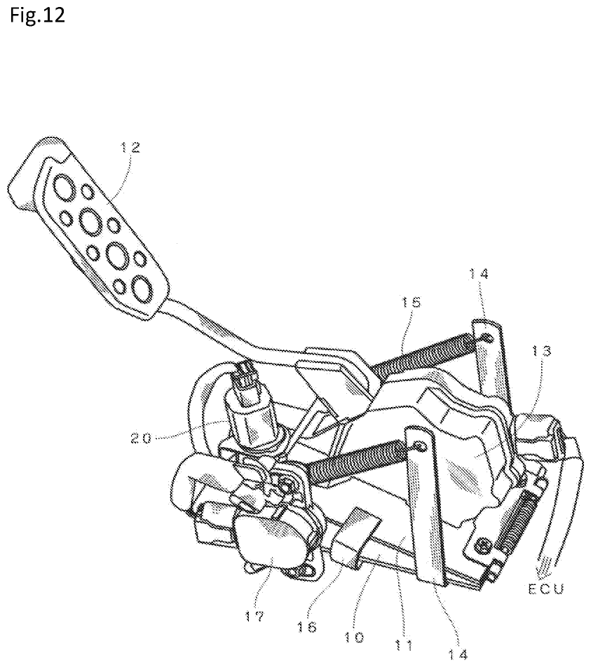

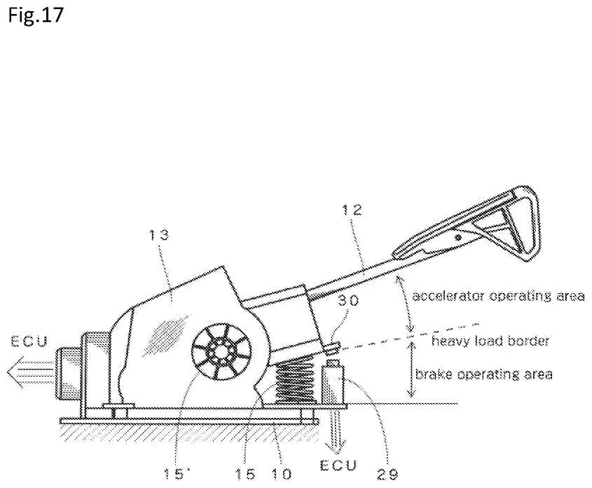

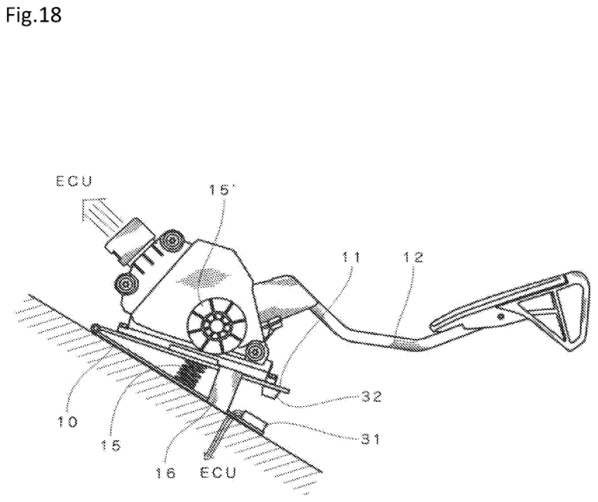

The accelerator-brake operation conversion system may also be implemented specifically with the following analog control devices as shown FIGS. 10 to 19, among which FIGS. 11 to 13 show a hanger spring pedal type where emergency substrates are supported by hanger coil springs, while as shown in FIGS. 4 and 5, 10, 15, 17, 18 and 19 show an organ pedal type where emergency substrates are supported from the base plate by coil springs 107, 25 and 15.

The accelerator-brake conversion pedal device according to the present invention is an analog device that controls an accelerator operation region and a brake operation region in which the accelerator pedal moves with a depressing force necessary during normal acceleration, while the accelerator pedal moves with a depressing pressure F(s) shown in FIG. 3 on the basis of correlation data FIG. 2 during abnormal acceleration. Therefore, the present inventive device can prevent runaway caused by erroneous operation of the accelerator pedal during abnormal acceleration, where an emergency operation base (11) is pivoted and biased to a base plate (10) attached to a fixed structure portion of the vehicle body side by a first spring member which supports the emergency operation base (11), while a normal accelerator pedal (12) is mounted on the emergency operation base (11) and is biased by a second spring member by which the normal accelerator pedal (12) is supported.

Therefore, an accelerator operating region of the accelerator pedal (12) is provided with 1) an accelerator operating region (27) biased by a second spring member, and 2) a heavy load braking region (28) biased by the first spring member and divided with a heavy lord border (26). The biasing force of the first spring member and the second spring member are adjusted under consideration of depressing pressure F(s) shown in FIG. 3 on the basis of correlation data FIG. 2 between the body weight W and the depressing force F.

In the brake operation area (28), a brake sensor (17) for detecting a tilting operation of the emergency operation base (11) is co-operated with an accelerator position sensor (13) built in an accelerator device for detecting a depression angle of an accelerator pedal (12) in the accelerator operation area (27), and the accelerator position sensor (13) outputs a signal to an engine control unit (ECU) to actuate the throttle driving means while the brake sensor (17) sends a signal to an engine control unit to stop the throttle driving means to actuate the brake driving means.

Since in the electric vehicle, the motor driving means is used in place of the throttle driving means, the above mechanism is applicable without changing the summary in the electric vehicle for controlling the motor driving means.

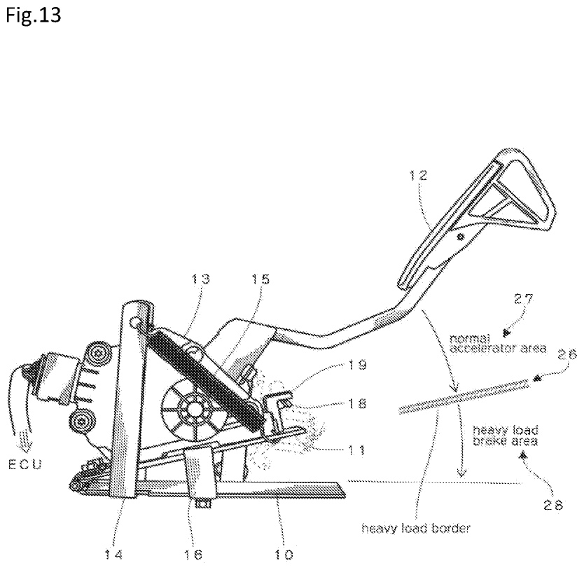

In the above preferred first embodiment as shown in FIGS. 11 to 13, where one end portion of the emergency operating base (11) mounted to the fixed structure portion (10) of the vehicle body is pivotally supported, when the accelerator pedal (12) is depressed below the biasing force of the first spring member (set value A), that is, when the stepping (normal accelerator region) not exceeding the heavy load wall (26) as shown in FIG. 13, the biasing force of the first spring member (15), preferably, together with the stopper (16) support the emergency operating base (11) at the normal position, and the engine control unit (ECU) operates the throttle driving means to drive the engine (or motor) by the normal acceleration operation.

On the other hand, when the accelerator pedal is depressed over the second spring member biasing force and on or over the first spring member biasing force (set value A), in other words, when stepping on or over the heavy load wall (26) in FIG. 13, the brake sensor detects the tilting action of the emergency operating base (11) and stops the throttle driving by the engine control unit (ECU) to bring the engine back to idle and activates the brake drive means. In the present invention, since the brake is actuated by reliably detecting a malfunction of the accelerator pedal (12), the biasing force of the emergency operation base (11) ensures the cooperative operation of the tilting plate and the brake switch to ensure safe operation.

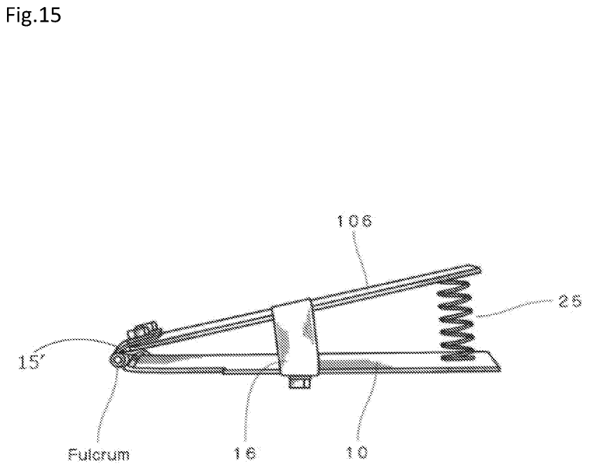

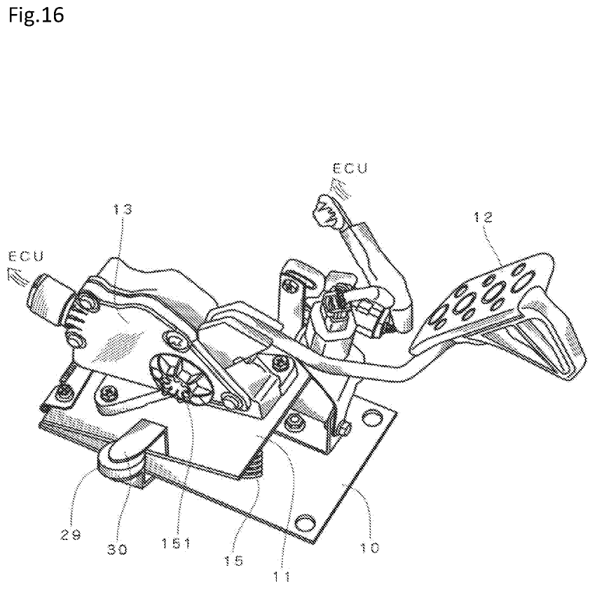

In another embodiment shown in FIGS. 16, 17 and 18 the emergency operation base (11) is provided with the flange piece 30 for pressing the pressure switch or sensor (29), (31) and (32) which is protruded from the side surface of the emergency operation base (11). Another emergency operation base (11) is biased so as to form a brake operation region (28) of the heavy load by the coil spring (15) (first spring member) in the same manner as in FIG. 15. On the other hand, the accelerator pedal (12) is biased by a low load, second spring member, or winding spring (151) provided in the normal acceleration mechanism on the emergency operation base (11), to form an accelerator operation region (27).

In FIGS. 16, 17 and 18, the emergency operation base (11) is provided with a switch pressing button (30) and (32) downwardly attached to the tip side thereof, and the lowering of the emergency operation base (11) switches a pressure sensor (29) and (31). Here, the pressure sensor has a function of judging as a physical abnormality of the driver and stopping the vehicle if the sensed pressure does not fluctuate for a predetermined period of time or longer.

As the accelerator mechanism, an organ type mechanism shown in FIGS. 10, 14, 15, and 19 can be used. In FIG. 10, the accelerator pedal (110) of the accelerator mechanism (105) is mounted on the emergency operation substrate (106), which is provided separately from the accelerator pedal (110), so that the emergency operation substrate (106) can impart a spring drag, corresponding to the above-described set value A necessary for switching between the accelerator and the brake by the biasing spring (107) as the first spring. The spring drag can be set in a manner of stepwise on the basis of the setting values of FIG. 3 when using the illustrated spring. Further, the drag force can be set by an electromagnetic operation or by a compressed air pressure of the air spring. In such a case, the correlation data in FIG. 2 can be applied as a calibration curve when the drag force is adjusted, and the predetermined set value A is adopted.

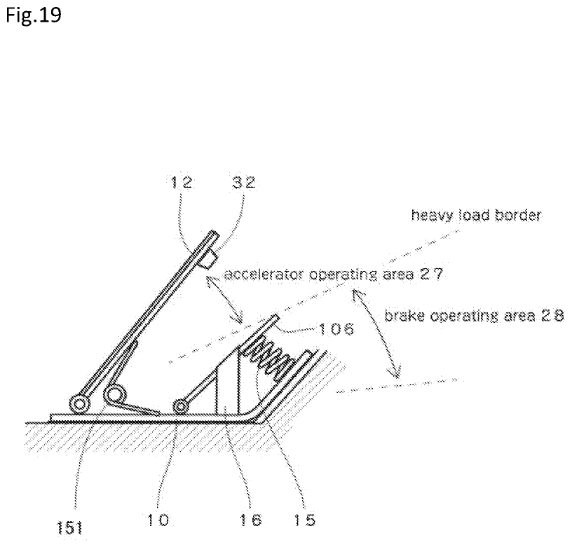

In FIG. 19, the emergency operating substrate (106) is biased with a coil spring (15) installed on the base plate (10) to form a brake operating region (28) of the high load, while the accelerator pedal (12) forms an accelerator operating region (27) with a torsion spring (151). As shown in FIG. 15, the emergency operation substrate (106) may provide the base plate (10) with a drag force to accelerate and brake the emergency operation substrate (106) connected via a V-shaped spring via a fulcrum by a coil spring (25).

Although a single spring member is shown in FIGS. 15 and 19, according to the present invention, the spring drag force A can be selected for each driver body weight as shown in FIG. 3. In addition, it is possible to adjust the drag value A in a manner of stepwise or stepless corresponding to the body weight W in a case of using an electromagnetic spring or an air spring.

In the analog aspect of the present invention, the normal operation area and the brake operation area are provided in the accelerator operation area by the depressing angle and/or the depressing force of the accelerator pedal (12) without providing the above-described tilting plate, and are divided by the difference in the spring constants of the first brake member 15 and the second brake member (151) in classifying them by the high load wall. However, this may be performed regardless of the emergency operation base. If the flange piece (30) is made to protrude forward from the mounting portion of the brake accelerator pedal (12) so as to abut against the sensor switch (29) provided below, while the accelerator pedal operation is performed by the second spring member (151) having a weak biasing force for the normal accelerator operation area while the first spring member (15) having a strong biasing force is provided for the emergency brake operation area, so the two area can be distinguished, and the control can be performed so as not to enter the brake operation during the normal accelerator operation but to take the brake operation only in the emergency. At this time, for example, the first tilting operation of the accelerator pedal may be performed by the coiling spring (151) in FIGS. 16 to 19, and the second tilting operation of the accelerator pedal may be performed by the coil spring (15). Further, in order to classify the normal accelerator operation area and the brake operation area by the load of the accelerator operation, with the mechanical difference in the spring constants of the first and second spring members, this operation can also be performed under the control of an electromagnetic system, a compressed air spring system, or the like. The identification of the operating area by the difference of the stepping force or pressure is the safest discrimination action, but the operating amount or the operating angle can be incorporated together with detection of stepping force or pressure, and the safety of the operation can be increased more than the single detection.

Thus, when the driver is panic and the accelerator pedal is depressed more strongly, it is possible to automatically and reliably apply the brake, and to suppress the runaway of the vehicle. The device of the present invention can be combined with other anti-collision systems or devices to prevent collisions with obstacles and prevent personal injury.

In short, according to the present invention, it is important to limit the brake operation to enter the brake operation during the normal acceleration operation so that the acceleration operation leading to the collision does not occur due to the malfunction caused by the unavoidable operation in an emergency. Especially, the normal accelerator mechanism on the emergency operation board is provided according to the present invention, so that the normal accelerator operation and the brake operation can be distinguished, resulting in avoiding an accident due to the panic operation or the malfunction in an emergency.

Hereinafter, the analog system of the present invention will be described in detail with reference to a specific example shown in the drawings.

FIGS. 11 to 13 show a preferred embodiment of the analog accelerator/brake converter according to the present invention. In the figure, the base plate (10) is attached to the vehicle body floor (fixed structure portion of the vehicle body side), at a one end side of the base plate (10) an emergency operation base (11) is pivoted by spring members (15) and (15′).

An accelerator device (13) with a built-in accelerator position sensor is mounted on the emergency operation base (11), and one end portion of a rod of the accelerator pedal (12) is pivotally supported on the accelerator device (13) so as to be supported in a swingable manner, and the accelerator pedal (12) is biased toward a non-depressed position by spring members (15) and (15′), and is positioned and locked to a non-depressed position by a stopper (16), and a depressing operation of the accelerator pedal (12), specifically, a depressing amount and a depressing speed are detected by an accelerator position sensor.

Further, in FIGS. 11 to 13, the rear portion of the base plate 10 is provided with the left and right spring mounting stays (14) erected at the both side, while the coil spring (15) is stretched between the top portion of the spring mounting stay (14) and the front portion of the emergency operation base (11), and the base plate (10) is fixed by a L-shaped stopper (16), the stopper (16) is adapted to lock the base plate (10) to the initial position against the biasing force of the coil spring (15).

Further, the base plate (10) is provided with a brake sensor (17), the rod (18) of the brake sensor (17) is connected by such as being inserted into the lower side of the inverted L-shaped lever (19) of the emergency operation base (11), the rod (18) of the brake sensor (17) is actuated by the tilting operation of the emergency operation base (11) brake operation, specifically adapted to detect the depressing speed of the accelerator pedal (12).

When the emergency operation base (11) is operated within the normal accelerator region (27) where the accelerator pedal (12) is depressed below a predetermined strength or below a predetermined depression angle, i.e., does not reach the heavy load wall (26), the emergency operation base (11) is positioned and held at an initial position, and normal accelerator operation is performed.

Also, when the accelerator pedal (12) is depressed above a predetermined strength or above a predetermined depression angle, i.e., is operated in the heavy load brake region (28) beyond the heavy load wall (26), tilting from an initial position of the emergency operation base (11) is allowed against the biasing force of the coil spring (15).

Furthermore, the emergency operation base (11) is provided with a brake lamp switch (20), so as to light the brake lamp when the brake is activated.

The signals of the accelerator device (13) built-in accelerator position sensor and brake sensor (17) are input to an engine control unit (ECU) to actuate known throttle drive means to drive the engine while actuating known brake drive means to operate the brake.

Since the emergency operation base (11) is held in the initial position by the biasing force of the coil spring (15) and the locking of the stopper (16) and does not tilt when the accelerator pedal (12) is depressed in the normal accelerator region (27), the depressing amount and the depressing speed of the accelerator pedal (12) are detected by the accelerator position sensor built in the accelerator device (13), and the ECU activates the throttle driving means to control the acceleration and deceleration of the engine and the traveling at a constant speed.

On the other hand, when the accelerator pedal (12) is depressed more than a predetermined strength or more than a predetermined depression angle and more strongly, the emergency operation base (11) is tilted in the heavy load brake region (28) from the initial position against the biasing force of the coil spring (15), and the brake sensor (17) detects the depression amount of the accelerator pedal (12), and the ECU stops the throttle driving means to return the engine to the idle state and sends a signal to the brake driving means to actuate the brake to automatically stop the vehicle.

Since the tilting operation of the emergency operation base (11) is strongly limited by the coil spring (15) in the normal acceleration operation, the brake cannot be applied, and the driver is not panic by the brake even if the driver presses the accelerator pedal (12) greatly during a normal attempt for accelerating.

Further, when the driver is panic and the accelerator pedal (12) is depressed more strongly, the engine can be returned to the idle state and the brake can be automatically applied, so that runaway of the vehicle can be suppressed, and there is no possibility of causing a collision with an obstacle and a personal injury accident.

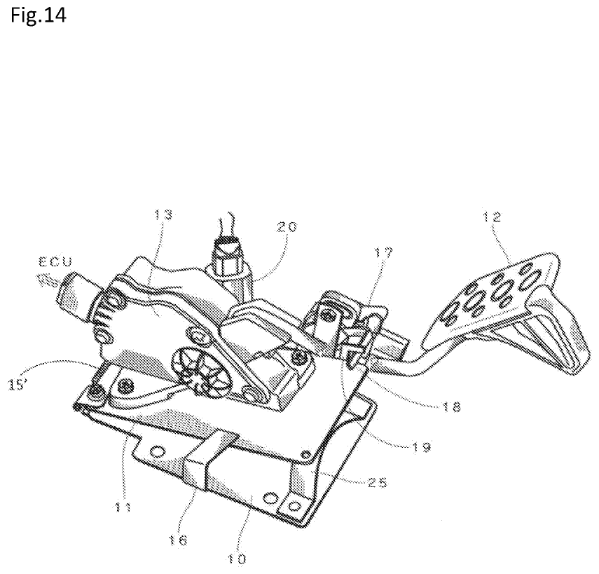

FIG. 14 shows a second embodiment, in which the same reference numerals as in FIGS. 11 to 13 indicate the same or corresponding parts. In this example, instead of the hang coil spring (15), a bent plate spring (25) is adopted to eliminate the spring mounting stay (14) and the emergency base plate (106) is made by V-shape spring plate provided with a coil spring (15′) between a connecting end portion of the base plate (10) and the emergency operation base (11). In a case of FIG. 19, the accel pedal is biased by a torsion spring (151) as the second spring member and the emergency base plate (106) is biased by a coil spring (15) as the first spring member.

Instead of the plate spring (25) in FIG. 14, as shown in FIG. 15, the base plate (10) and the emergency operation base (11) may be constructed by V-shape plate (106) with the coiling spring (15′) and further biased by the coil spring (25).

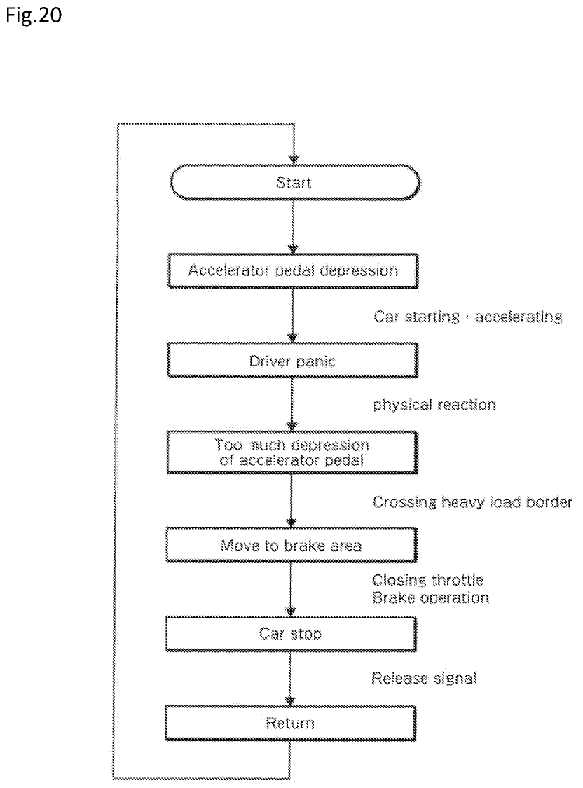

In order to deal with a driver who has a difficulty maintaining the muscle force of depression until the vehicle stops even if depression is instantaneously performed with a strong force, a mechanism is provided for temporarily stopping and holding the emergency operation base in accordance with the amount of depression, such as the stopper 16. The temporary stop holding mechanism can be easily released after the vehicle stops. That is, according to the present invention, as shown in FIG. 20, the throttle is opened by the accelerator pedal to start and accelerate the vehicle. Then, if the driver malfunctions due to some panic, the foot protrudes in the physical reaction. When the accelerator pedal is forcefully depressed by this, the pedal passes over the heavy-duty wall and enters the brake operation area from the accelerator operation area. Since this action is sensed by the brake sensor, as shown in FIG. 9, the throttle is closed through the ECU (500) and the brake is actuated, resulting in the vehicle stopping and preventing runaway accidents. In this stopped state, a release signal is transmitted by restarting the accelerator to return to the original point.

Although described with reference to a gasoline engine vehicle in the above embodiment, by controlling the motor driving means in place of the throttle driving means even in an electric vehicle, it is possible to control the same. Further, in the above-described embodiment, in the accelerator operation region, the normal operation region and the brake operation region are distinguished by the difference in the spring constant, but it is easy for a person skilled in the art to switch the depressing load variation of the accelerator pedal by switching the low load resistance and the heavy load resistance by electromagnetic means so as to distinguish the low load region from the heavy load region. That is, the normal operation area and the brake operation area can be continuously provided in the operation area of the accelerator pedal, and an electromagnet brake consisting of two types of load strengths that impart a low load resistance to the accelerator operation area and a heavy load resistance to the brake operation area can be provided, so that a heavy load wall is formed between the two. As a result, the normal operation and brake operation can be converted each other without mistake. In addition, it is of course possible to combine the mechanical operation conversion system by the spring constant with the digital operation conversion system of electromagnetic load resistance by electrical switching.

### DESCRIPTION OF SYMBOLS

10 Base plate,
11 Emergency operating board,
12 Accelerator pedal,
13 Accelerator with built-in accelerator position sensor,
14 Spring Mounting Stay,
15 Coil spring (high load spring member),
151 low load spring member,
16 Stopper,
17 Brake sensor,
18 Rod of the brake sensor,
19 Inverted L-shaped lever,
20 Brake lamp switch,
25 Leaf spring or coil spring (spring member),
26 Heavy-duty wall,
27 Normal accelerator area,
28 Heavy duty brake area,
29 Emergency Stop Button,
30 Emergency button,
31 Pressure sensor,
32 Pressure contacting part,
33 platform locking position retaining spring,
100 Operation seat,
200 Pressure sensor,
300 Control system,
400 AI computing system,
500 Automatic vehicle-to-vehicle distance adjustment system ECU

1: A digital system for shutting off an accelerator function and converting the accelerator function immediately into a brake function for safety in the event of a malfunction when an accelerator pedal is accidentally depressed by a panic or the like, which comprises;
a step for determining an accelerator/brake switching set value A correlating to the driver's respective body weight W based on a correlation data showing the relation between the driver's body weight W and the depressing force F of the accelerator pedal,
a step for holding the set value A to an artificial intelligence device AI of ECU (Engine Control Unit),
a step for detecting the pedaling depressing pressure F(s) of the driver,
a step for transmitting the signal S as the depressing pressure F(s) to the artificial intelligence device AI of ECU,
a step for comparing the depressing pressure F(s) with the set value A hold in the AI of ECU,
a step for outputting the operation continuation signal D-yes from the ECU when the pedaling pressure F(s) is smaller than the set value A (F(s)<A), while outputting the operation stop signal D-no from the ECU to shut off the accelerator function and converting it immediately into a brake function when the depressing pressure F(s) is greater than or equal to the set value A (F(s)≥A).

2: An analog system for shutting off an accelerator function and converting the accelerator function immediately into a brake function for safety in the event of a malfunction when the accelerator pedal is accidentally depressed by a panic or the like, which comprises;
an accelerator mechanism for operating an accelerator pedal with a depressing force necessary for normal acceleration and an emergency operation board for operating a brake on which the accelerator mechanism is mounted, wherein a correlation data showing a relationship between a driver's body weight W and a depressing force F of the accelerator pedal is obtained and a switching force A is calculated on the basis of this, and the emergency operation board is set to be biased by a first spring member in order to be operated only when the depressing force F of the accelerator pedal is the same or greater than the setting value A (F(s)≥A), resulting in that the emergency operation board can operate in response to this, and the above-mentioned throttle driving means is stopped and a brake drive means is actuated to actuate a normal brake and/or an electric parking brake.

3: The system according to claim 1, wherein when the switching value A is calculated on basis of the correlation data showing a relationship between a driver's body weight W and a depressing force F under a condition that the accelerator depressing pressure F (s)=depressing force F×X/Y, where X is a distance from the fulcrum of the accelerator mechanism to the accelerator depressing point (force point), and Y is a distance from the fulcrum of the accelerator mechanism to the pressure sensor (action point), and when F (s)<0.8×W×(X/Y), F (s) is determined as a normal operation, while when F (s)≥0.8×w×(X/Y), F (s) is determined as an abnormal normal operation

4: A system for shutting off the accelerator function and converting the accelerator function immediately into a brake function for safety in the event of a malfunction when the accelerator pedal is accidentally depressed by a panic or the like, wherein the digital type system according to claim 1 is combined and co-operated with the analog type system which comprises;
an accelerator mechanism for operating an accelerator pedal with a depressing force necessary for normal acceleration and an emergency operation board for operating a brake on which the accelerator mechanism is mounted, wherein a correlation data showing a relationship between a driver's body weight W and a depressing force F of the accelerator pedal is obtained and a switching force A is calculated on the basis of this, and the emergency operation board is set to be biased by a first spring member in order to be operated only when the depressing force F of the accelerator pedal is the same or greater than the setting value A (F(s)≥A), resulting in that the emergency operation board can operate in response to this, and the above-mentioned throttle driving means is stopped and a brake drive means is actuated to actuate a normal brake and/or an electric parking brake.

5: An analogue type accelerator-brake convertor for shutting off an accelerator function and converting the accelerator function immediately into a brake function for safety in the event of a malfunction when the accelerator pedal is accidentally depressed by a panic or the like, which comprises:
a base plate which is attached to the fixed structure portion of the vehicle body, a movable emergency operation base mounted on the base plate and biased in a manner to a predetermined initial position by a first spring member,
an accelerator mechanism provided with an accelerator pedal mounted on the emergency operation base and biased toward a predetermined non-depressed initial position by a second spring member and also provided with an accelerator position sensor for detecting the depression angle of the accelerator pedal to actuate the throttle drive or motor driving means,
wherein the biasing force of the first spring member and the second spring member are adjusted in a manner that an accelerator operating area is divided into a normal operation area biased by the second spring member and a brake operation area biased by the first spring member and wherein a brake sensor is provided for detecting the tilting operation of the emergency operation base in the brake operation area, and when the brake sensor receives a signal from the tilting operation of the emergency operation board, the signal is sent to an engine control unit (ECU) to stops the throttle drive or motor driving means and actuate the brake driving means.

6: An analogue type accelerator-brake convertor according to claim 5, which further comprises a stopper for locking said emergency operating base in its initial position against the forces of said first spring members.

7: An analogue type accelerator-brake convertor according to claim 5, wherein the first spring member for holding the emergency operation base at an initial position is a coil spring stretched between a spring mounting stay on the base plate and the emergency operation base.

8: An analogue type accelerator-brake convertor according to claim 5, wherein
the accelerator brake operation conversion device according to claim 5, wherein the first spring member for holding the emergency operation base in the initial position is a plate spring or a coil spring interposed between the front portion of the base plate and the front portion of the emergency operation base.

9: An analogue type accelerator-brake convertor according to claim 5, wherein the first spring member and the second spring member are formed by an electromagnet brake or a pressure varying air spring having two or more strengths for providing a low load resistance and a heavy load resistance to make the normal operation area and the brake operation area of the accelerator.

10: An analogue type accelerator-brake convertor according to claim 5, wherein the first spring member for providing a heavy load resistance is provided with a resistance property for setting value A selected from the correlation data between the driver weight W and the pedal depressing force F.

11: An analogue type accelerator-brake convertor according to claim 5, wherein the first spring member for providing a heavy load resistance is provided with a resistance property for setting value A selected from the correlation data between the driver weight W and the pedal depressing force F wherein when the switching value A is calculated on basis of the correlation data showing a relationship between a driver's body weight W and a depressing force F under a condition that the accelerator depressing pressure F (s)=depressing force F×X/Y, where X is a distance from the fulcrum of the accelerator mechanism to the accelerator depressing point (force point), and Y is a distance from the fulcrum of the accelerator mechanism to the pressure sensor (action point), and when F (s)<0.8×W×(X/Y), F (s) is determined as a normal operation, while when F (s)≥0.8×W×(X/Y), F (s) is determined as an abnormal normal operation.
